(19) United States
(12) Patent Application Publication
(10) Pub. No.: US 2014/0280555 A1
(43) Pub. Date: Sep. 18, 2014

(54) SOCIAL NETWORKING FOR SURFERS

(71) Applicants: William F. Tapia, Weston, CA (US); Benjamin Pei-Ming Chia, Cupertino, CA (US); Stephen Hooper, Bellingham, WA (US); Laurence Brian McGann, Santa Cruz, CA (US); Stanley Pratt, III, Watsonville, CA (US)

(72) Inventors: William F. Tapia, Weston, CA (US); Benjamin Pei-Ming Chia, Cupertino, CA (US); Stephen Hooper, Bellingham, WA (US); Laurence Brian McGann, Santa Cruz, CA (US); Stanley Pratt, III, Watsonville, CA (US)

(21) Appl. No.: 13/839,294

(22) Filed: Mar. 15, 2013

(51) Int. Cl. H04L 29/08

(52) U.S. Cl. CPC H04L 67/10
USPC 709/204

(57) ABSTRACT

Systems and methods are disclosed for communicating surfing experience by capturing pictures or videos of one or more surfers; uploading the pictures or videos to a remote host computer; creating at least one collage from the pictures or videos, wherein items in the collage are variably sized based on one or more predetermined factors; and sharing the collage with at least another user.

This application is related to application Ser. Nos. 13/839,294; 13/839,858; 13/839,792; 13/839,733, all filed concurrently herewith, the contents of which are incorporated by reference.

### BACKGROUND

This invention relates to surfing experience sharing ecosystem.

Surfing is the movement of a board through the face of the wave. Surfing is becoming a very popular sport and it seems like once someone starts surfing they never stop. Some famous surfing spots include Hawaii, California, Costa Rica, Southern Africa and more. Surfing is all about the wave and in fact it is all about “my wave”.

In a parallel trend, social networks, or social utilities that track and enable connections between members (including people, businesses, and other entities), have become prevalent in recent years. In particular, social networking websites allow members to communicate relevant information more efficiently. For example, a member may post contact information, background information, job information, hobbies, and/or other member-specific data to a location associated with the member on a social networking website. Other members can then review the posted data by browsing member profiles or searching for profiles including specific data. The social networking websites also allow members to associate themselves with other members, thus creating a web of connections among the members of the social networking website.

Conventionally, when a user who is also a member of a social network wishes to share information with other members of the social network, the user generally copies and pastes the information to a location on the social network or forwards the information in the form of a message or email to other members. Often, certain forms of information do not copy and paste very well from one medium to another, and additional formatting or modifications to the information may be required before it is suitable for viewing by other members. Moreover, members who receive this shared information and subsequently wish to forward it may be required to repeat the formatting process. As a result, the quality of shared information may be compromised and members may be less likely to share information with each other. Furthermore, outdated shared information may accumulate in locations within the social network, further dampening the incentive for members to share content. Additionally, there is often no way of tracking the shared information within the social network.

US Application 20090144392 discloses a system where a user selects a control for sharing content from the external system that causes a sharing request to be sent. The sharing request is received by the social networking website, and an interface is presented to the user requesting sharing parameters. The user provides sharing parameters through the interface that are received by the social networking website. Content is retrieved from the external system and is transmitted to one or more destinations in the social networking website based at least in part on the sharing parameters. The sharing parameters may include selection parameters for indicating which content to share, formatting parameters for specifying how to format the content, and destination parameters indicating particular destinations in the social networking website for the content.

### SUMMARY

In one aspect, a process for communicating surfing experience includes capturing pictures or videos of one or more surfers; uploading the pictures or videos to a remote host computer; creating at least one collage from the pictures or videos, wherein items in the collage are variably sized based on one or more predetermined factors; and sharing the collage with at least another user.

Implementation of the above aspect can include one or more of the following. The collage can be shared with another user. The collage can be identified by a dotted line with a scrolling button on the dotted line. A “More” button can be positioned at the end of the dotted line to expand the collage and view more collage content. The dotted line can superimpose dates on the dotted line and become a time line. The user can view items in the collage chronologically, each item separated by date. The user can adjust collage parameters and edit a filter or a tag or removing the parameters. The user can add tags, likes and comments. The method includes displaying received media content for a video as a wave progressing across a bar chart as content is received in a media content buffer. Each video or picture in the collage can be sized according to popularity or number of views. The user can create a group page where content is determined by group members. An event widget can be provided to professional users or event managers. The method includes generating a locale page showing conditions for a predetermined area, selecting content based on user-tagged content, and displaying an image of area by a geotagged location. The user can generate a pro-user profile page with customizable background image, event widget, and sponsor widget. The system can generate an event profile page with event detail, competing professional information, customizable background image, event widget, and sponsor widget. The system can show images of the user's gear(s) and favorite combination(s) of gears. The system can show all gears with clickable thumbnails to show in larger thumbnail area. The system provides e-commerce capability, enabling users to sell or trade the gears. On-line stores can be created for professional users and event managers. The system provides a 3D experience by capturing 3D images and videos and subsequently showing them to viewers on the web site. The video content can be edited using tools provided by the web site. Surf games can be played on the web site.

In another aspect, a process for communicating surfing experience includes capturing pictures or videos of one or more surfers; uploading the pictures or videos to a host computer; creating at least one collage from the pictures or videos; showing a user's surfing equipment; and trading or selling the user's surfing equipment with other users in the network.

In yet another aspect, a system for communicating surfing experience includes a camera mounted on a surf-board to capture one or more pictures or videos of one or more surfers; a remote host computer to receive the pictures or videos and to support creation of at least one collage from the pictures or videos, wherein items in the collage are variably sized based on one or more predetermined factors, wherein the remote host computer shares the collage in a social network; and a transceiver coupled to the camera to transmit the one or more videos or pictures to the remote host computer.

### BRIEF DESCRIPTION OF THE DRAWINGS

The disclosed embodiments have other advantages and features which will be more readily apparent from the following detailed description and the appended claims, when taken in conjunction with the accompanying drawings, in which:

FIG. 1A shows an exemplary surfing experience sharing network.

FIG. 1B shows an exemplary account creation and collage set-up process.

FIGS. 1C-1F show exemplary user pages for the account creation and collage set-up process of FIG. 1B.

FIG. 2 shows an exemplary process to share or communicate surfing experience.

FIGS. 3A-3P show exemplary web pages illustrating a user interface for the process of FIG. 2.

FIG. 4A shows an exemplary camera that can be head-mounted or surfboard mounted.

FIG. 4B shows an exemplary 3D camera.

FIG. 5 shows an exemplary surfboard mounted camera configuration.

FIGS. 6A-6B show an exemplary camera housing bandana configuration.

FIGS. 7A-7B show another headmount embodiment, but with a head strap and a sunshield or visor that can be optionally mounted on the headmount.

FIG. 7C shows another camera embodiment with wide angle lens and a lanyard or carabiner securing system.

FIG. 8 shows an exemplary digital camera schematic.

### DETAILED DESCRIPTION

FIG. 1A shows an exemplary surfing experience sharing network. Surfing is very addictive and that is the reason why it is growing in population and it is also the reason why someone would surf from age 5 to age 70. The water provides a natural peace and the waves are beautiful to watch. The system of FIG. 1A enables surfers to share images and videos of their favorite activity and provide a social network linking the surfer community with each other and with commercial suppliers, among others.

FIG. 1A shows an exemplary architecture with surfing experience sharing servers, and in this embodiment the servers communicate through a database or backend server 32. In FIG. 1A, a plurality of surfers 50 capture videos and pictures of their surfing activities and such videos/pictures are uploaded through laptop 10, smartphone 42 and cell phone 44, among others. The content is sent through a network 20 such as the Internet. The system can also directly communicate with cameras with WiFi connection or with wired connectors such as USB or Firewire, for example. For example, the surfer can upload video using the laptop 10 that communicates with a Web Application Server 30, which in turn communicates with the database system 32. The system 32 in turn communicates with a Customer Relationship Management (CRM) server 34 and a Finance Server 36, for example. The Finance Servers enable the system with ecommerce capabilities so that customers can be charged for viewing videos or purchasing items, among others. The advantage of this type of architecture is that the applications can operate more or less independently of each other. If any one of the applications should go off-line, the other servers can still provide service until the application becomes operational again. In a typical scenario, the number of queues being managed is reasonably small and roughly proportional to the number of enterprise applications. In principle, this architecture can be used to extend communications to occasionally connected mobile devices with addition of a Mobile Communications Server 40 which handles the transmission of message to and from mobile devices 10, 42 and 44 and the exchange of these messages with the DB system 32. In this exemplary enterprise system, multiple applications are used to support various business functions. These applications may need to exchange information in order to keep data within each application consistent across the enterprise. For instance, there may be a Web Application which collects information entered by customers, there may be a Customer Relationship Management (CRM) system that maintains information about customers and there may be a Financial System that maintains information about customers and their accounts. Whenever a customer record is updated in one of these systems, the other systems may be informed using applications exchange messages such as a Message Exchange System, among others.

In one embodiment, the Web Application Server 30 runs a surfer-optimized social networking website that allows surfers to communicate or otherwise interact with each other and access content as described herein. The social networking website stores member profiles that describe the members of a social network, including biographic, demographic, and other types of descriptive information, such as work experience, educational history, hobbies or preferences, location, and the like. The website further stores data describing one or more relationships between different members. The relationship information may indicate members who have similar or common work experience, group memberships, hobbies, or educational history. Additionally, the social networking website may include member-defined relationships between different members, allowing members to specify their relationships with other members. For example, these member-defined relationships allows members to generate relationships with other members that parallel the members' real-life relationships, such as friends, co-workers, partners, and so forth. Members may select from predefined types of relationships, or define their own relationship types as needed.

The client devices can be one or more computing devices that can receive member input and can transmit and receive data via the network 20. For example, the client devices may be desktop computers, laptop computers, smart phones, personal digital assistants (PDAs), or any other device including computing functionality and data communication capabilities. The client devices are configured to communicate via network 20, which may comprise any combination of local area and/or wide area networks, using both wired and wireless communication systems. The client devices 20 may be running a web browser that allows users at the client devices to view web pages served by the social networking website or external websites. These users may be members of the social networking website. Other applications similar to web browser may also be run on the client device to view content from the social networking website or external websites.

Another embodiment uses Google App Engine in the cloud on the server side to support a social network data model, and Google Web Toolkit (GWT) on the client side to integrate the dynamic social network data from the server with template HTML and CSS for each webpage, resulting in a dynamic user experience. By restricting the cloud-based server to managing the data model keeps Google App Engine transaction time low and the resulting costs low. By putting more of the computational burden in supporting the web page look and feel on the client computer with GWT, high performance is achieved by leveraging the otherwise idle client processor and costs low since client processor bandwidth is for the most part free. The Google App Engine enables the system of FIG. 1A to run on a provider such as Google's infrastructure. App Engine applications are easy to build, easy to maintain, and easy to scale as your traffic and data storage needs grow. With App Engine, there are no servers to maintain: You just upload your application, and it's ready to serve surfers. Google App Engine supports apps written in several programming languages. With App Engine's Java runtime environment, the app uses standard Java technologies, including the JVM, Java servlets, and the Java programming language—or any other language using a JVM-based interpreter or compiler, such as JavaScript or Ruby. App Engine also supports dedicated Python runtime environments, each of which includes a fast Python interpreter and the Python standard library. These runtime environments are built to ensure that your application runs quickly, securely, and without interference from other apps on the system. App Engine includes the following features:
dynamic web serving, with full support for common web technologies
persistent storage with queries, sorting and transactions
automatic scaling and load balancing
APIs for authenticating users and sending email using Google Accounts
a fully featured local development environment that simulates Google App Engine on your computer
task queues for performing work outside of the scope of a web request
scheduled tasks for triggering events at specified times and regular intervals

FIG. 1B shows an exemplary account creation and collage set-up process. In this process, a user or viewer can create an account at SU1-1 and subsequently create a collage at SU2. The user or viewer can review the Terms of Service at SU1-2 and/or the User Rules at SU1-3. The collage can be a user collage (SU2-1) or a paid professional account (SU2-2).

FIGS. 1C-1F show exemplary user pages for the account creation and the collage set-up process of FIG. 1B. As shown in FIG. 1C, at an entry point, the user can either log in, sign up, or when clicking onto content is prompted to do one or the other. After clicking sign up, the user is able to create an account, invite friends, and also agrees to the rules and terms of use in FIG. 1D. In FIG. 1E, the site assists the user in starting his or her content by creating a collage. By default, the collage is pre populated with suggestions for tags and filters and a various pre-determined connections. At this point the user may add more connections and filters to broaden his or her network and experience. In FIG. 1F, the account initialization is nearly done, and the avatar and biography can be populated at this point.

FIG. 2 shows an exemplary process to share or communicate surfing experience. In this process, pictures or videos of one or more surfers are captured using a video camera (102). Camera images and videos from all commercial vendors can be received and processed by the system, however, specific 3D cameras or low profile cameras or anatomically secured cameras provide the best user experience on the site. The user then uploads the pictures or videos from the camera to a remote host computer (104). After signing-in, the user is prompted to create a collage from the pictures or videos (110). Each collage is identified by a dotted line with a scrolling button on the dotted line (112). The process provides a “More” button at the end of the dotted line to expand the collage and view more collage content (114). A timeline can be shown on the dotted line and view items in the collage chronologically, each item separated by date (116). The user can adjust collage parameters and editing a filter or a tag and add tags, likes and comments (118). The process automatically sizes each video or picture in the collage according to popularity or number of views (120). For example, the process gives greater prominence to pictures or videos that are viewed more frequently (popular). In one embodiment, size represents the number of times that picture or video has been viewed. This is useful as a means of displaying metadata about an item that has been democratically “voted” on and where precise results are not desired. In a second embodiment, size represents the number of items to which a tag has been applied, as a presentation of each tag's popularity. In the third type, tags are used as a categorization method for content items. Tags are represented in a cloud where larger tags represent the quantity of content items in that category. From a user interface perspective they are often used to summarize results to support the user in finding popular videos or pictures more quickly. The user can tweak the view with different fonts, layouts, and color schemes.

The user can share the collage with at least another user as a social network (122). In one embodiment, the system can display received media content for a video as a wave progressing across a bar chart as content is received in a media content buffer (124).

The system can also support groups by allowing users to create a group page where content is determined by group members (126). The system can also generate a locale page showing conditions for a predetermined area, selecting content based on user-tagged content, and displaying an image of area by a geotagged location (128). For professional users, the system can generate a professional-user profile page with customizable background image, event widget, and sponsor widget (130).

For event managers, the system can generate an event profile page with event detail, competing professional information, customizable background image, event widget, and sponsor widget (132).

Additionally, for users who want to show case their gears, the system can show images of the user's gear(s) and favorite combination(s) of gears with clickable thumbnails that show a large image when clicked (134). An on-line store is provided for users to sell or trade the gears (136).

The system can be used initially for creating and organizing a social network consisting of organizations, manufacturers, retailers and/or individuals who have a common goal of working to promote, expand and grow the sport of surfing. Members of the network can include one or more of the following: 1) celebrity surfers and professional board sport athletes, 2) branded surf retailers that are in the business of selling and marketing surf related products, including clothing, beachwear and other related products, and in particular, those branded retailers that sponsor professional surfing athletes; 3) branded manufacturers of surf related equipment such as surf boards and bodyboards, and in particular, those manufacturers that sponsor professional surfing athletes; 4) manufacturers of water rides and wave generating technologies; and 5) surf dedicated media partners that distribute surfing content to its audience, e.g., TV networks (ESPN, OLN, FOX, FUSE, GrindTV, etc.,) or print/web publications (Surfer, Surfing, Transworld Surf, Happy, Surfline, Swell, Surfer's Village, etc.).

The celebrity surfers can include those who are well-known to the industry, and preferably, to most consumers. Celebrities can bring perceived value and legitimacy to the consortium's activities and functions, and therefore, to the developers. For example, celebrity surfers can be hired or asked to participate in designing and/or testing certain surfing products, which can bring added-value, legitimacy and prestige to the companies. Celebrities can participate in the competitive events that are sponsored and conducted by the consortium, to raise interest in and bring publicity to the events. Celebrities can be hired or asked by the branded surf retailers to do commercials and participate in advertising, which can help cross-promote their branded products with the development. Users can get positive feedback from their surfing expertise through the images and videos showing their skill, and the feedback can result in recognition or monetary rewards, among others.

The system can be used as a means of bringing together a number of branded retailers in the surfing industry, and obtaining commitments from them to support surfers. In turn, the surf retailers can use the system to create an emotional connection between the real ocean, the sport of surfing, and optimally, their retail brand, thereby legitimizing their products. Additionally, the surf retailer can use their brand advertising and commercials to cross promote their surf brands with the development. This can give celebrity surfers an incentive to incorporate the package into their user page, and develop on-line storefront space for the retailers. The system can include branded surf retailers that sponsor professional athletes to wear their branded retail goods. Current examples include: Quiksilver®, Billabong®, Hurley®, Volcom®, O'Neill®, Reef®, Rip Curl®, and Rusty®. An added benefit that the surf retailers bring is that they can generate national and international interest, with broad consumer appeal, wherein the marketing and promotional campaigns that they develop can be extended to national and international markets. That is, the campaigns can be designed to promote the development to potential consumers from around the world, wherein the campaigns could provide benefits in the form of extensive marketing and promotional value to the product developers. In one embodiment, the system does not present advertising and rely on user subscription or sales for revenue. In another embodiment, ads can be show as a revenue source.

The system can support competitive, professional or demonstrative events, such as by professional athletes sponsored by the branded surf retailers and conducted in. A competitive event is one that includes athletes competing for prize money awards, or other valuable consideration, and a professional event is one that uses paid athletes. The competitive events can have teams that compete against one another, which can be part of a league or circuit. The league or circuit can be part of, or be distinct from, the current Association of Surfing Professionals (ASP/WQS), or International Surfing Association (ISA) or similar sports league. The system may promote each team, either as teams, or as individuals within each team. Individual competitions, such as those for individual prize money, can also be conducted. For example, the system may partner with television studios, such as ESPN, OLN, and FOX, who can be permitted to distribute opening event competition, invitational, and ultimately a competitive circuit and content from such TV studios can be rendered in the user's collages.

In FIG. 3A, collages are identified by dotted line on left instead of brackets. A share button is provided next to the collage title so users can suggest this collage to a friend or other users. The number of new views is also provided above each video or picture. In FIGS. 3B-3C, when the user scrolls down, a sea more icon can be clicked to view more content from the current collage. In one embodiment, users can create another collage by pressing a plus bar at the top of the collage collection. Collages, once clicked into can be viewed chronologically, items line separated by date as shown in FIG. 3D. Collage parameters can be adjusted by clicking the edit button. Users can toggle definitions between being a filter, tag, or removed completely. The user can also perform a preview to see what the overall content looks like before saving changes.

FIG. 3F shows a media view, where users can add tags to content, share, like (hot!), and comment. The media buffer shows up as a wave progressing across as the content buffers in one embodiment. FIG. 3G shows a media uploader where users may add media content by dragging images or videos into the uploader box or by clicking on a “Browse your Computer” button. The users may also select multiple objects to tag. To change tags or descriptions, users may click on an individual item to edit. FIG. 3H shows an exemplary user home page, where the user's content is shown, including blog posts, check-ins, and media content. In one embodiment, editing buttons are provided to help user perform basic editing of video. The system supports basic settings such as stabilization, brightness, contrast, and saturation. Special effects filters similar to those found on apps like Instagram are supported as well. Any changes made to a video are non-destructive, meaning the user can easily flip back to the original. The system can allow a member to charge viewers for viewing or downloading of pictures and videos of skilled surfers.

FIG. 3I shows an exemplary groups page. The group page shows similar information as a user page, but includes an event widget. Content is determined by group members. The group page can be edited to include a customizable background color. FIG. 3J shows an exemplary user interface for creating a group. The page captures information such as group name, tag, location and details. The group can be a regular group or a premium group. Administrators can be added, and members can be invited to join the group.

FIG. 3K shows an exemplary locale page. The locale page shows conditions for the area, content is dictated by user-tagged content. Image of area is generated by geo-tagged location. The background color can determined by designated regions.

FIG. 3L shows an exemplary blog entry. Users can view a blog entry, tag, like (hot!), share, comment, and edit. FIGS. 3M-3O show exemplary social networking pages where users can search their network for users, pros, locales, groups, and (all). As the user types into the search field, content is auto filtered alphabetically. Further, the system can recommend surfers who have similar interests to a user. Updates to a user's account are summarized in an update page as shown in FIG. 3O. Users can search the site for content, filters can be toggled on and off. Content is first filtered by uploader type, then by content type.

The system also provides a search page where users can search by keyword(s), as shown in FIG. 3P. The keywords can match tags or descriptive text entered with the video or pictures. The system can match videos to an input image by using visual descriptors. Through the visual descriptors the system can analyze the frames of a video and extract information that can be scored as metadata. Descriptions are generated automatically and can describe different aspects of the frames, such as color, texture, shape, motion, and the situation. To facilitate video search, speech recognition can identify a transcript of the speech of the audio track of the videos, creating a text file. In this way and with the help of a phrase extractor can easily search if the video content is of interest. The transcript can be used to find the specific point of a multimedia file in which the searcher cites a specific word or phrase and so go directly to this point, allowing the user to go directly to exact moment that the words were spoken.

To facilitate searching and manipulating video and graphic content on the site, an identifier is created for each graphic or video file from pieces of information herein called identifier information. As shown in the examples below, an identifier for a video file comprises one or more of the following: a text string or other searchable attribute of a whole, segment, frame, or sub element of a video. The identifiers are used to consistently identify a whole, segment, frame, or sub element of a video respectively. An identifier for a graphic file comprises a text string or other searchable attribute of the graphic file. Examples of identifiers are shown below. For example, a whole video identifier can have one or more of the following:
Format of video stream
Size of video stream
Location (GPS coordinate)
Play time of video stream (including number of frames)
Whether or not sound is contained
Date of creation
Category of video stream
Text description of the video stream (This may also be broken down into additional fields including: content, author, director, year made, category, surfer, owner)
Representative frame of the video stream
Representative audio stream
Number of identified segments in the video stream Number of identified frames in the video stream
A unique ID
Linking and other association information

FIG. 4A shows an exemplary camera with a curved body 300 that can be head-mounted or surfboard-mounted. The camera includes a moveable arm 310 that rotates out to expose one or more connectors 312 on either side of the camera body. The arm 310 can be a side rubber strip or other suitable materials that provide a seal or waterproof protection for the connectors 312 when the arm 310 is closed. The arm also allows the camera to stand on a desktop. The camera 300 has a lens 314 that is optimized for capturing surfing images or videos. In one embodiment, the lens 314 is fixed, and in another embodiment, a servomotor can adjust the focus for improved sharpness. One or more buttons 316 is positioned on the body 300 to allow the user control the camera such as to start and stop recording videos, among others. One or more openings 319 are positioned at each corner of the camera body 300 to allow the user to see the outputs of display devices such as LED displays. These displays may be turned on in a predetermined sequence to indicate that filming is on or that a setting has been selected, for example. A ring 318 is positioned at one end of the lens for subsequent attachment to a helmet, head band, or bandana to secure the camera to the head. Such helmets and bandanas require no effort in carrying the camera and convenient for surfers to use while securing the camera to the surfer. FIG. 4B shows a 3D camera embodiment. In this embodiment, two lenses capture two images near each other to allow a stereo view to be present that simulates a 3D view.

FIG. 5 shows a surf-board mounted camera. Although the disclosed embodiments include a mount for attaching a camera to a sporting board, for example a surfboard, windsurfing board, kite surfing board, skateboard, snowboard, skis, or a wakeboard. For ease of description, references will be made to a surfboard, but the principles described herein are understood to be applicable to other sporting boards. In one embodiment, a low profile can be used to take better pictures and videos.

Turning now to FIG. 5, the camera body 300 is inside of a protective enclosure 330 that provides an access port to the lens 314 and button 316, among others. The protective enclosure 330 has an attachment base 328 that is suitably hingedly connected to an elevation adjustment structure 326 which is surrounded by buttons 324 and positioned on a post 322. To adjust the elevation of the camera, the user pushes down on the adjustment structure 326. To tilt the camera, the user squeezes the buttons 324 and tilts the camera body 300. The unit can be flipped back to aim at the surfer. The post 322 is mounted on top of a base 320 and rotates on the base 320 to prevent scratching the surfboard. Once mounted, the camera can point in the same direction as the surfer's view, or alternatively can point the other way to capture images of the surfer.

In various embodiments, the camera mount can be placed on the front of the surfboard or the rear of the surfboard. Furthermore, the mount can be configured to face either forwards or backwards to capture images and/or video from different viewpoints while surfing. Moreover, the mount can include a pivoting joint to allow a user to rotate the camera either upward or downward and then secure the camera at a fixed angle to capture images and/or video from different angles. Beneficially, the camera mount allows a user to securely, safely, and easily carry a camera while surfing in a manner which does not handicap the user's participation in surfing.

In one embodiment, the camera can be a 3D camera with two lenses

Turning now to FIGS. 6A-6B, a wearable camera mount system is shown. The bandana has a front portion 340 that is rotatably connected to a rear portion 342 at a joint with a pivot pin 344. The front portion 340 has extension arms 342 to allow the user to select the appropriate hole in the extension arm and adjust the size of the bandana to snugly fit the user's head. The front portion 340 has an opening to receive the camera lens 314 and a magnetic ring 348 that securely engages the ring 318 on the camera body 300. One or more pushbuttons 346 are provided on the front portion 340 that, when pushed by the user, makes mechanical contact with the corresponding pushbuttons 316 on the camera body 300.

Once the camera has been secured to the bandana, the bandana takes seconds to wear and adjust, yet it can support the camera in the perfect position for the entire surfing session, helping surfers to take great still and motion photography by preventing camera movement. The head-worn camera minimizes any camera movement while the shutter is open to reduce a blurred image. In the same vein, the bandana reduces camera shake, and thus are instrumental in achieving maximum sharpness.

The head-mount system allows a user to securely mount a camera to the head to capture images and/or video during activity involving the user without taking away from the user's ability to surf or participate in other similar activities. Beneficially, the mount provides a solid platform projecting from the user's head in a variety of positions and angles to allow for the capture of images (still and/or video) from the perspective of the surfer without camera shaking or other instability when taking videos.

In one embodiment, the bandana is a two-piece assembly, with a front portion 340 having an opening to receive the camera lens 314. Each portion can be molded from a single piece of flexible material containing a plurality of rigid elements integrally carried therein. The flexible two piece bandana elements deform independently of each other to the extent required to conform to the wearer's head. The bandana is easily and inexpensively manufactured in a variety of forms to meet certain functional and esthetic requirements. In other embodiments, instead of a bandana, a baseball cap, hood, or other close fitting clothing can be used.

FIGS. 7A-7B show another headmount embodiment, but with a head strap and a sunshield or visor that can be optionally mounted on the headmount. FIG. 7C shows another camera embodiment with wide angle lens and a lanyard or carabiner securing system.

FIG. 8 shows an exemplary camera schematic. A processor 502 communicates over a bus with memory such as RAM 504 and ROM 506. The processor (CPU) 502 also communicates with a USB transceiver 508 to allow the user to transfer data from memory to a remote computer. The processor 502 also communicates with a wireless transceiver 510 such as Bluetooth to allow wireless data transfer with the remote phone, tablet or computer. In one embodiment, the camera is completely sealed to provide waterproofing. In another embodiment, the camera has a flash memory receptacle 507 that allows common flash modules to be inserted into the camera to provide high capacity video storage and expandability. The CPU 502 also controls a servo motor 512 to adjust the focus of the lens 318. Light captured by an image sensor 500 is processed by the CPU 502. Additionally, one or more displays 514 can be driven by the CPU 502. In one embodiment, the displays 514 can be LEDs positioned at four corners of the camera to provide visual feedback to the surfer. In another embodiment, an OLED display can be provided to show the user the image or video being captured.

The image sensor 500 can be a charge coupled device (CCD) or a complementary metal oxide semiconductor (CMOS) device. Both CCD and CMOS image sensors convert light into electrons. Once the sensor converts the light into electrons, it reads the value (accumulated charge) of each cell in the image. A CCD transports the charge across the chip and reads it at one corner of the array. An analog-to-digital converter (ADC) then turns each pixel's value into a digital value by measuring the amount of charge at each photosite and converting that measurement to binary form. CMOS devices use several transistors at each pixel to amplify and move the charge using more traditional wires. The CPU 502 can be a low power processor such as an ARM processor and can run Android as an embedded operating system in one embodiment.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. Those of skill in the art will understand the wide range of structural configurations for one or more elements of the present invention. For example, certain elements may have square or rounded edges to give it a particular look. Further, particular elements of the present invention that are joined or attached to one another in the assembly process can be made, molded, machined, or otherwise fabricated as a single element or part. In addition, certain elements of the present invention that are fabricated as a single element or part can be fabricated as separate elements or in a plurality of parts that are then joined or otherwise attached to one another in the assembly process. Certain elements of the present invention that are made of a particular material can be made of a different material to give the device a different appearance, style, weight, flexibility, rigidity, reliability, longevity, ease of use, cost of manufacture, among others.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention.

While the above description contains much specificity, these should not be construed as limitations on the scope, but rather as an exemplification of preferred embodiments thereof. Accordingly, the scope of the disclosure should be determined not by the embodiment(s) illustrated, but by the appended claims and their legal equivalents.

What is claimed is:

1. A process for communicating surfing experience, comprising
capturing pictures or videos of one or more surfers using a camera;
uploading the pictures or videos from the camera to a remote host computer;
creating at least one collage from the pictures or videos, wherein items in the collage are variably sized based on one or more predetermined factors; and
sharing the collage with at least another user.

2. The process of claim 1, comprising providing video editing functions including stabilization, brightness, contrast, saturation, and special effects filters, wherein the user flips back to an original on-demand.

3. The process of claim 1, comprising identifying a collage by a dotted line with a scrolling button on the dotted line.

4. The process of claim 3, comprising providing a “More” button at the end of the dotted line to expand the collage and view more collage content.

5. The process of claim 3, comprising showing a timeline on the dotted line.

6. The process of claim 3, comprising viewing items in the collage chronologically, each item separated by date.

7. The process of claim 1, comprising adjusting collage parameters and editing a filter or a tag.

8. The process of claim 1, comprising capturing a 3D picture or 3D video of a surfer.

9. The process of claim 1, comprising displaying received media content for a video as a wave progressing across a bar chart as content is received in a media content buffer.

10. The process of claim 1, comprising sizing each video or picture in the collage according to popularity or number of views.

11. The process of claim 1, comprising creating a group page where content is determined by group members.

12. The process of claim 1, wherein a viewer pays for viewing or downloading of pictures and videos of a surfing event.

13. The process of claim 1, comprising generating a locale page showing conditions for a predetermined area, selecting content based on user-tagged content, and displaying an image of area by a geotagged location.

14. The process of claim 1, comprising generating a professional-user profile page with customizable background image, event widget, and sponsor widget.

15. The process of claim 1, comprising generating an event profile page with event detail, competing professional information, customizable background image, event widget, and sponsor widget.

16. The process of claim 1, comprising showing images of the user's gear(s) and favorite combination(s) of gears.

17. The process of claim 16, comprising enabling users to sell or trade the gears.

18. A process for communicating surfing experience, comprising:
capturing pictures or videos of one or more surfers;
uploading the pictures or videos to a host computer;
creating at least one collage from the pictures or videos;
showing a user's surfing equipment; and
trading or selling the user's surfing equipment with other users in the network.

19. The process of claim 19, comprising capturing 3D surfing experience and displaying the experience for a viewer as a 3D image or 3D video.

20. A system for communicating surfing experience, comprising:
a camera mounted on a surf-board to capture one or more pictures or videos of one or more surfers;
a remote host computer to receive the pictures or videos and to support creation of at least one collage from the pictures or videos, wherein items in the collage are variably sized based on one or more predetermined factors, wherein the remote host computer shares the collage in a social network; and
a transceiver coupled to the camera to transmit the one or more videos or pictures to the remote host computer.

21. The system of claim 20, comprising a dotted line to identify the collage, wherein the dotted line includes a scrolling button, a “More” button at the end of the dotted line to expand the collage and view more collage content, and a timeline.

22. The system of claim 20, comprising an e-commerce module to charge customers for viewing video.
